(19) United States
(12) Patent Application Publication
(10) Pub. No.: US 2025/0386132 A1
(43) Pub. Date: Dec. 18, 2025

(54) Coaxial Speaker

(71) Applicant: AAC Microtech (Changzhou) Co., Ltd., Changzhou City, Jiangsu Province (CN)

(72) Inventors: Zhang Ren, Shenzhen (CN); Zhiwei Zhong, Shenzhen (CN)

(21) Appl. No.: 17/913,831

(22) PCT Filed: Jul. 20, 2022
(86) PCT No.: PCT/CN2022/106747

§ 371 Date: Mar. 28, 2025

(30) Foreign Application Priority Data
Jun. 30, 2022 (CN) 202221690591.6

(51) Int. Cl. H04R 1/24; H04R 1/06; H04R 7/12; H04R 7/18; H04R 9/02; H04R 9/06

(52) U.S. Cl. CPC H04R 1/24; H04R 1/06; H04R 7/127; H04R 7/18; H04R 9/025; H04R 9/063; H04R 2400/11

(57) ABSTRACT

A coaxial speaker is provided, including a first frame, a second frame surrounded by the first frame, a first sounding unit fixed between the two frames, a second sounding unit coaxial with and surrounded by the first sounding unit fixed to the second frame, and a magnetic circuit system including a bottom plate, a first magnetic unit and a second magnetic unit spaced apart from the first magnetic unit for forming a first magnetic gap for the first sounding unit. The second magnetic unit includes a second magnet in an annular shape and a second yoke in an annular shape. The bottom plate is provided with a bending wall locating inside the second magnetic unit, the bending wall is spaced apart from the second magnetic unit for forming a second magnetic gap for the second sounding unit. The coaxial speaker reduces a product height and a magnetic circuit system cost.

### TECHNICAL FIELD

The present disclosure relates to electroacoustic transducers, in particular to a coaxial speaker.

### BACKGROUND

A coaxial speaker means that a speaker has two sounding units emitting high frequency sounds and mid-low frequency sounds respectively and these two sounding units are set on the same axis. A coaxial speaker in the related art has two sounding units stacked in a height direction, resulting in an excessive product height which reduces product applicability. In addition, each sounding unit has an individual and separate magnetic circuit system, resulting in an excessive magnetic circuit system cost which reduces product market competitiveness.

Thus, it is necessary to provide a novel coaxial speaker to solve the problem.

### SUMMARY

An objective of the present disclosure is to provide a coaxial speaker which reduces a product height and a magnetic circuit system cost.

In order to achieve the objective mentioned above, the present disclosure discloses a coaxial speaker including a first frame, a second frame surrounded by the first frame, a magnetic circuit system, a first sounding unit and a second sounding unit. The magnetic circuit system includes a bottom plate, a first magnetic unit and a second magnetic unit. The first magnetic unit includes a first magnet disposed on the bottom plate and a first yoke attached to the first magnet. The second magnetic unit is arranged on an inner side of the first magnetic unit and spaced apart from the first magnetic unit for forming a first magnetic gap, and includes a second magnet in an annular shape disposed on the bottom plate and a second yoke in an annular shape attached to the second magnet. The bottom plate is provided with a bending wall locating inside the second magnetic unit, the bending wall is spaced apart from the second magnetic unit for forming a second magnetic gap. The first sounding unit includes a first diaphragm and a first voice coil locating in the first magnetic gap and driving the first diaphragm for vibrating and emitting sounds. An outer fixing part of the first diaphragm is fixed to the first frame, an inner fixing part of the first diaphragm is fixed to the second frame. The second sounding unit is coaxial with and surrounded by the first sounding unit, and includes a second diaphragm fixed to the second frame and a second voice coil locating in the second magnetic gap and driving the second diaphragm for vibrating and emitting sounds.

Further, the second frame is fixed to the second yoke.

Further, the first yoke includes a main body part attached to a surface of the first magnet and an extension part extending from the main body part in a direction away from the second magnetic unit, the first frame is fixed to the extension part.

Further, the first sounding unit includes an elastic supporting member opposite to and spaced apart from the first diaphragm, and a skeleton connected between the first diaphragm and the elastic supporting member, an amount of the extension parts is two, the two extension parts are respectively arranged on two opposite long-axis sides of the coaxial speaker, an amount of the elastic supporting members is two, the two elastic supporting members are respectively arranged on two opposite short-axis sides of the coaxial speaker, the skeleton includes two supporting arms respectively fixed to the two elastic supporting members, each supporting arm is arranged between the first frame and the first magnetic unit, an outer fixing portion of each elastic supporting member is fixed to the first frame, an inner fixing portion of each elastic supporting member is fixed to a corresponding one of the two supporting arms.

Further, each elastic supporting member includes a flexible printed circuit board fixed to a corresponding one of the two supporting arms and an auxiliary diaphragm fixed to a bottom surface of the flexible printed circuit board away from the first diaphragm.

Further, the second diaphragm includes a dome, the dome includes a recessed part recessed toward the magnetic circuit system and a protruding part protruding from a bottom of the recessed part in a direction away from the magnetic circuit system.

The first sounding unit and the second sounding unit of the coaxial speaker are arranged coaxially, and the first sounding unit surrounds the second sounding unit, thereby reducing a product height. The magnetic circuit system includes the bottom plate, the first magnetic unit and the second magnetic unit spaced apart from the first magnetic unit for forming the first magnetic gap for the first sounding unit, and the bottom plate is provided with a bending wall locating inside the second magnetic unit and spaced apart from the second magnetic unit for forming the second magnetic gap for the second sounding unit, thereby improving structural utilization of the magnetic circuit system and reducing a magnetic circuit system cost.

### BRIEF DESCRIPTION OF THE DRAWINGS

In order to more clearly illustrate the technical solutions in embodiments of the present disclosure, the accompanying drawings used in the description of the embodiments will be briefly introduced below. It is apparent that, the accompanying drawings in the following description are only some embodiments of the present disclosure, and other drawings can be obtained by those of ordinary skill in the art based on the accompanying drawings without creative efforts, wherein:

FIG. 1 is an isometric view of a coaxial speaker in accordance with an exemplary embodiment of the present disclosure.

FIG. 2 is an exploded view of the coaxial speaker in FIG. 1.

FIG. 3 is a cross-sectional view of the coaxial speaker, taken along line A-A in FIG. 1.

FIG. 4 is a cross-sectional view of the coaxial speaker, taken along line B-B in FIG. 1.

### DETAILED DESCRIPTION OF THE EMBODIMENTS

The technical solutions in embodiments of the present disclosure will be described clearly and completely below with reference to the accompanying drawings in the embodiments of the present disclosure. It is apparent that, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

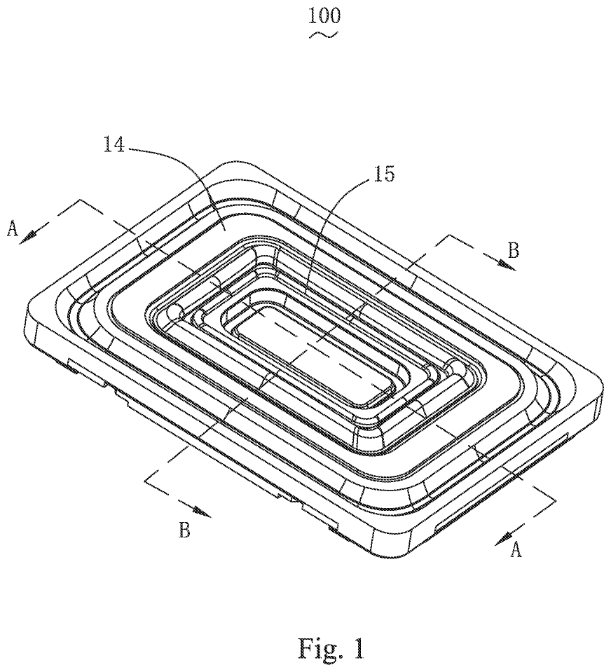

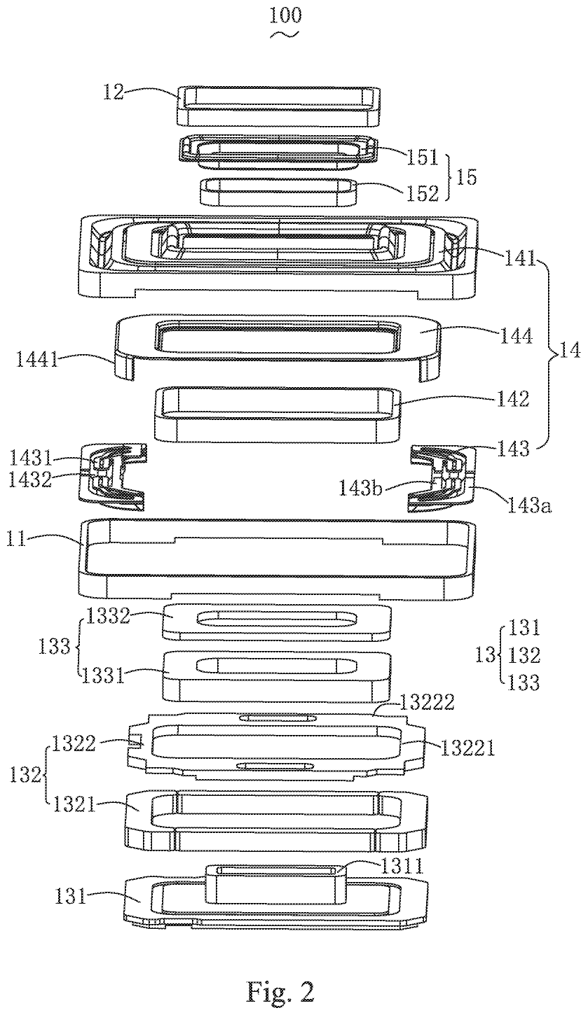

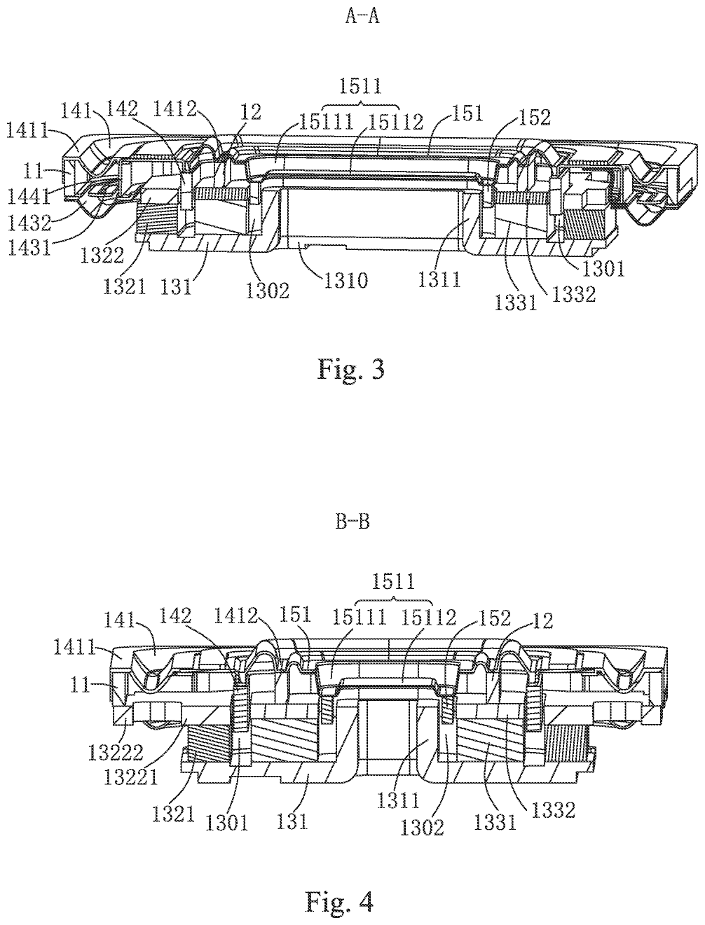

Referring to FIGS. 1-4, the present disclosure discloses a coaxial speaker 100 including a first frame 11, a second frame 12, a magnetic circuit system 13, a first sounding unit 14 and a second sounding unit 15 coaxial with the first sounding unit 14.

The first frame 11 surrounds the second frame 12. The first sounding unit 14 surrounds the second sounding unit 15.

The first sounding unit 14 includes a first diaphragm 141 and a first voice coil 142 driving the first diaphragm 141 for vibrating and emitting sounds. The second sounding unit 15 includes a second diaphragm 151 and a second voice coil 152 driving the second diaphragm 151 for vibrating and emitting sounds.

An outer fixing part 1411 of the first diaphragm 141 is fixed to the first frame 11, an inner fixing part 1412 of the first diaphragm 141 is fixed to the second frame 12. The second diaphragm 151 is fixed to the second frame 12. The first diaphragm 141 and the second diaphragm 151 are both fixed to the second frame 12, that is beneficial to adjust concentricity of the first diaphragm 141 and the second diaphragm 151.

The magnetic circuit system 13 includes a bottom plate 131, a first magnetic unit 132 and a second magnetic unit 133. The first magnetic unit 132 is arranged on an outer side of the second magnetic unit 133 and spaced apart from the second magnetic unit 133 for forming a first magnetic gap 1301. The first voice coil 142 locates in the first magnetic gap 1301. The first magnetic unit 132 includes a first magnet 1321 disposed on the bottom plate 131 and a first yoke 1322 attached to the first magnet 1321. The second magnetic unit 133 includes a second magnet 1331 in an annular shape disposed on the bottom plate 131 and a second yoke 1332 in an annular shape attached to the second magnet 1331. The bottom plate 131 is provided with a bending wall 1311 locating inside the second magnetic unit 133. The bending wall 1311 is spaced apart from the second magnetic unit 133 for forming a second magnetic gap 1302. The second voice coil 152 locates in the second magnetic gap 1302. The first yoke 1322 includes a main body part 13221 attached to a surface of the first magnet 1321 and an extension part 13222 extending from the main body part 13221 in a direction away from the second magnetic unit 133, an amount of the extension parts 13222 is two, the two extension parts 13222 are respectively arranged on two opposite long-axis sides of the coaxial speaker 100.

The first frame 11 is fixed to the two extension parts 13222. The second frame 12 is fixed to the second yoke 1332.

The first sounding unit 14 further includes an elastic supporting member 143 opposite to and spaced apart from the first diaphragm 141, and a skeleton 144 connected between the first diaphragm 141 and the elastic supporting member 143, an amount of the elastic supporting members 143 is two, the two elastic supporting members 143 are respectively arranged on two opposite short-axis sides of the coaxial speaker 100. The skeleton 144 includes two supporting arms 1441 respectively fixed to the two elastic supporting members 143, each supporting arm 1441 is arranged between the first frame 11 and the first magnetic unit 132. An outer fixing portion 143a of each elastic supporting member 143 is fixed to the first frame 11, an inner fixing portion 143b of each elastic supporting member 143 is fixed to a corresponding one of the two supporting arms 1441.

The second diaphragm 151 includes a dome 1511, the dome 1511 includes a recessed part 15111 recessed toward the magnetic circuit system 13 and a protruding part 15112 protruding from a bottom of the recessed part 15111 in a direction away from the magnetic circuit system 13. A shape of the dome 1511 can make the dome 1511 has an enough structural strength and reduce a weight itself.

Each elastic supporting member 143 includes a flexible printed circuit board 1431 fixed to a corresponding one of the two supporting arms 1441 and an auxiliary diaphragm 1432 fixed to a bottom surface of the flexible printed circuit board 1431 away from the first diaphragm 141. The first voice coil 142 is electrically connected to an external power supply through the flexible printed circuit board 1431.

The bottom plate 131 is provided with a through hole 1310 enclosed by an inner edge wall of the bottom plate 131, the bending wall 1311 extends from the inner edge wall. The through hole 1310 communicates with a column hole enclosed by the bending wall 1311. An insert for electrically connecting the second voice coil 152 with an external power supply can be arranged in the communication area. Optionally, the communication area can also contain other functional insert such as sound-absorbing materials and thermal conduction materials for achieving different functional purposes.

The first sounding unit 14 and the second sounding unit 15 of the coaxial speaker 100 are arranged coaxially, and the first sounding unit 14 surrounds the second sounding unit 15, thereby reducing a product height. The magnetic circuit system 13 includes the bottom plate 131, the first magnetic unit 132 and the second magnetic unit 133 spaced apart from the first magnetic unit 132 for forming the first magnetic gap 1301 for the first sounding unit 14, and the bottom plate 131 is provided with a bending wall 1311 locating inside the second magnetic unit 133 and spaced apart from the second magnetic unit 133 for forming the second magnetic gap 1302 for the second sounding unit 15, thereby improving structural utilization of the magnetic circuit system 13 and reducing a magnetic circuit system cost.

The above are only embodiments of the present disclosure. It should be pointed out that those of ordinary skill in the art may also make improvements without departing from the ideas of the present disclosure, all of which fall within the protection scope of the present disclosure.

### SUMMARY

Technical problem
Solutions for the technical problem
Beneficial Effects of the present disclosure

What is claimed is:

1. A coaxial speaker, comprising:
a first frame;
a second frame surrounded by the first frame;
a magnetic circuit system comprising:
a bottom plate;
a first magnetic unit comprising a first magnet disposed on the bottom plate and a first yoke attached to the first magnet; and
a second magnetic unit arranged on an inner side of the first magnetic unit and spaced apart from the first magnetic unit for forming a first magnetic gap, comprising a second magnet in an annular shape disposed on the bottom plate and a second yoke in an annular shape attached to the second magnet, wherein, the bottom plate is provided with a bending wall locating inside the second magnetic unit, the bending wall is spaced apart from the second magnetic unit for forming a second magnetic gap;
a first sounding unit comprising a first diaphragm and a first voice coil locating in the first magnetic gap and driving the first diaphragm for vibrating and emitting sounds, wherein an outer fixing part of the first diaphragm is fixed to the first frame, an inner fixing part of the first diaphragm is fixed to the second frame; and
a second sounding unit coaxial with and surrounded by the first sounding unit, comprising a second diaphragm fixed to the second frame and a second voice coil locating in the second magnetic gap and driving the second diaphragm for vibrating and emitting sounds.

2. The coaxial speaker as described in claim 1, wherein the second frame is fixed to the second yoke.

3. The coaxial speaker as described in claim 1, wherein the first yoke comprises a main body part attached to a surface of the first magnet and an extension part extending from the main body part in a direction away from the second magnetic unit, the first frame is fixed to the extension part.

4. The coaxial speaker as described in claim 3, wherein the first sounding unit further comprises an elastic supporting member opposite to and spaced apart from the first diaphragm, and a skeleton connected between the first diaphragm and the elastic supporting member, an amount of the extension parts is two, the two extension parts are respectively arranged on two opposite long-axis sides of the coaxial speaker, an amount of the elastic supporting members is two, the two elastic supporting members are respectively arranged on two opposite short-axis sides of the coaxial speaker, the skeleton comprises two supporting arms respectively fixed to the two elastic supporting members, each supporting arm is arranged between the first frame and the first magnetic unit, an outer fixing portion of each elastic supporting member is fixed to the first frame, an inner fixing portion of each elastic supporting member is fixed to a corresponding one of the two supporting arms.

5. The coaxial speaker as described in claim 4, wherein each elastic supporting member comprises a flexible printed circuit board fixed to a corresponding one of the two supporting arms and an auxiliary diaphragm fixed to a bottom surface of the flexible printed circuit board away from the first diaphragm.

6. The coaxial speaker as described in claim 1, wherein the second diaphragm comprises a dome, the dome comprises a recessed part recessed toward the magnetic circuit system and a protruding part protruding from a bottom of the recessed part in a direction away from the magnetic circuit system.
